(19) United States
(12) Patent Application Publication
(10) Pub. No.: US 2009/0016443 A1
(43) Pub. Date: Jan. 15, 2009

(54) INTER MODE DETERMINATION METHOD FOR VIDEO ENCODING

(75) Inventors: Jong-Ho KIM, Busan (KR); Byung-Gyu Kim, Busan (KR); Chang-Sik Cho, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/057,104

(22) Filed: Mar. 27, 2008

(30) Foreign Application Priority Data
Jul. 11, 2007 (KR) 10-2007-0069553

(51) Int. Cl. H04N 7/12

(52) U.S. Cl. 375/240.24; 375/E07.17

(57) ABSTRACT

The present invention relates to a method for a video encoder to determine an inter mode. The video encoder selects first search modes by using optimized inter mode information of a correlation macroblock having the same position as a current macroblock in a previous frame, in order to determine the inter mode. The video encoder compares a rate-distortion cost of the correlation macroblock and a rate-distortion cost of the mode that is selected as the minimum cost mode from among the first search modes, and determines whether to terminate an inter mode determination process early. When the early termination condition is satisfied, the video encoder determines the search mode having the minimum rate-distortion cost from among the first search modes as the optimized inter mode of the current macroblock, and terminates the inter mode determination process early. When the early termination condition is not satisfied, the video encoder selects second search modes to additionally perform an inter prediction process, and determines the corresponding search mode having the minimum rate-distortion cost as the optimized inter mode of the current macroblock.

### CROSS-REFERENCE TO RELATED APPLICATION

This application claims priority to and the benefit of Korean Patent Application No. 10-2007-0069553 filed in the Korean Intellectual Property Office on Jul. 11, 2007, the entire contents of which are incorporated herein by reference.

### BACKGROUND OF THE INVENTION

(a) Field of the Invention

The present invention relates to an inter mode determination method for video encoding.

This work was supported by the IT R&D program of MIC/IITA [2005-S-022-02, Embedded Software-based SmarTown Solotion].

(b) Description of the Related Art

In a process for a video encoder based on the H.264/AVC (advanced video coding) method to compress block-based video data, residual data are reduced by the prediction encoding method, and block discrete cosine transform (DCT), quantization, and entropy coding are performed on the residual image, mode information, and motion vector to thus generate compressed data streams.

In this instance, the prediction encoding method is divided into inter prediction and intra prediction. The inter prediction uses the temporal correlation of the previous image, and the intra prediction uses the spatial correlation. For example, the H.264/AVC-based video encoder performs the intra prediction on the I-frame, and performs the inter prediction and intra prediction on the P-frame or B-frame.

The inter modes used by the inter prediction include 16×16, 16×8, 8×16, 8×8, 8×4, 4×8, and 4×4, and the video encoder calculates the rate-distortion costs for the respective modes, selects the inter mode having the minimum rate-distortion cost as the optimized mode, and performs a compression process.

In the case of the inter frame (P-frame or B-frame), the H.264/AVC type of video encoder performs the intra prediction and the inter prediction for each macroblock, and selects the mode having the lesser rate-distortion cost from among the inter mode and the intra mode that are selected based on the rate-distortion cost as the optimized mode of the current macroblock.

The inter/intra prediction allows the video encoder to increase compression efficiency while minimizing video data loss. However, realization of the inter/intra prediction generates a large amount of complexity since various types of inter/intra prediction processes must be performed for the respective macroblocks. Further, the huge complexity may restrict the system for processing video data in real-time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to reduce the complexity of a video encoder's determination on an inter mode.

In one aspect of the present invention, a method for determining an inter mode in a method for a video encoder to select an inter mode of a current macroblock to be encoded in a current frame includes selecting a first minimum cost mode according to an inter mode of a correlation macroblock having the same position as the current macroblock in a previous frame, and determining an inter mode of the current macroblock based on a rate-distortion cost of the first minimum cost mode and a rate-distortion cost of the correlation macroblock.

In another aspect of the present invention, a method for determining an inter mode in a method for a video encoder to select an inter mode of a current macroblock to be encoded in a current frame includes: selecting at least one first search mode according to an inter mode of a correlation macroblock having the same position as the current macroblock in a previous frame; selecting the minimum cost mode from among the at least one first search mode; determining whether to terminate an inter mode determination process early based on a rate-distortion cost of the minimum cost mode and a rate-distortion cost of the correlation macroblock; and determining the inter mode according to the determination result. The step of determining the inter mode includes determining the minimum cost mode as the inter mode when terminating the inter mode determination process, and selecting at least one second search mode and selecting the inter mode from among the minimum cost mode and the at least one second search mode when not terminating the inter mode determination process.

According to the exemplary embodiment of the present invention, the method for determining the inter mode by using inter mode information for each macroblock of a previous frame and performing an inter prediction process on a plurality of search modes reduces complexity of the video encoder compared to the conventional inter mode determination method for performing an inter prediction process on the full modes.

Also, the method increases reliability for the inter mode that is selected by using the early termination method, by using the rate-distortion cost of a macroblock of the same position as the current macroblock in the previous frame so as to determine whether to terminate the inter mode determination process early. Further, the method reduces complexity while decreasing the number of times for performing the inter prediction process for selecting the inter mode, by using rate-distortion cost information that is generated during the encoding process of the previous frame or inter mode information without adding additional calculation for performing the inter mode determination process.

### BRIEF DESCRIPTION OF THE DRAWINGS

FIG. 1 is a schematic diagram of a video encoder according to an exemplary embodiment of the present invention to encode data.

FIG. 2 is a flowchart for a video encoder according to an exemplary embodiment of the present invention to encode data.

FIG. 3 is a flowchart for a video encoder according to an exemplary embodiment of the present invention to select a first search mode so as to select an inter mode.

FIG. 4 shows search modes used for general inter prediction.

FIG. 5 is a tree-type search mode for general inter prediction.

FIG. 6 shows first search modes according to an exemplary embodiment of the present invention.

FIG. 7 shows a flowchart for a video encoder according to an exemplary embodiment of the present invention to determine an inter mode according to selection of a second search mode.

FIG. 8 shows an example of selecting a second search mode according to an exemplary embodiment of the present invention.

FIG. 9 shows neighboring macroblocks used for determining a second search mode according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

A method for a video encoder according to an exemplary embodiment of the present invention to determine an inter mode will now be described with reference to the accompanying drawings. The H.264/AVC type of video encoder will be exemplified in the exemplary embodiment of the present invention, and other types of video encoders using the inter mode are also applicable.

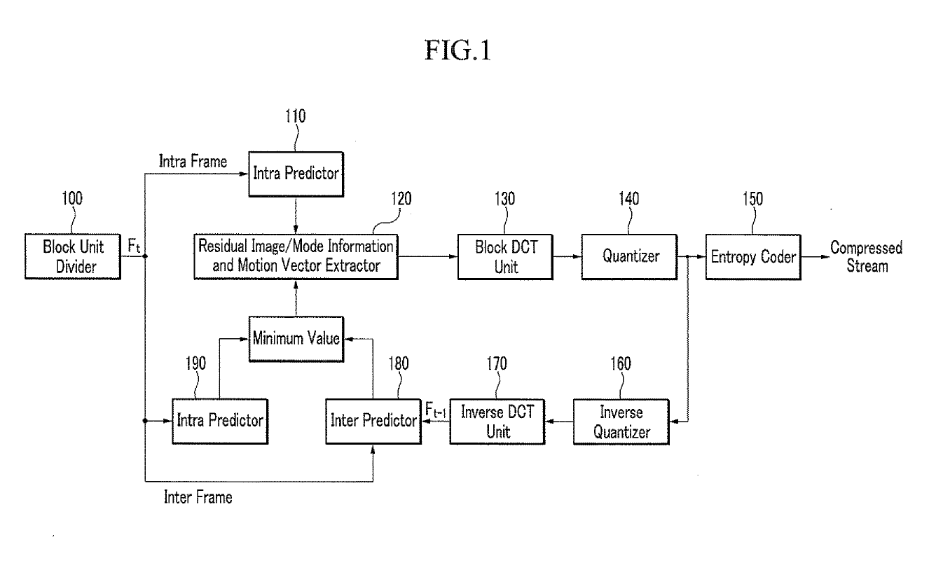

FIG. 1 shows a video encoder for compressing block-based data according to an exemplary embodiment of the present invention.

Referring to FIG. 1, the video encoder includes a block unit divider 100, intra predictors 110 and 190, residual image/mode information and motion vector extractor 120, a block discrete cosine transform (DCT) unit 130, a quantizer 140, an entropy coder 150, an inverse quantizer 160, an inverse DCT unit 170, and an inter predictor 180.

The video data input to the video encoder are classified as intra frame (I-frame) and inter frame (P-frame). The intra frame performs intra prediction, and the inter frame performs both intra prediction and inter prediction.

When the video data are input, the block unit divider 100 divides the video data that are input for each frame into macroblocks. The subsequent encoding process is performed by the macroblocks. For example, the macroblock may have a 16×16 block size in the H.264/AVC video encoder.

When the input video data corresponds to the intra frame, the intra predictor 110 performs intra prediction for each macroblock, and determines the intra mode having the minimum rate-distortion cost. The residual image/mode information and motion vector extractor 120 extracts residual image/mode information depending on the intra mode that has the minimum rate-distortion cost selected by the intra predictor 110. The extracted residual image/mode information is discrete cosine transformed by the block DCT unit 130 and is then quantized through the quantizer 140. The quantization result is processed to be a compression stream through the entropy coder 150.

When the input video data are an inter frame, the video encoder uses a previously-encoded previous frame so as to perform inter prediction. For this, the video encoder performs a compression process and a restoration process for each frame to use the restored frame for the next-frame inter prediction. That is, the video encoder uses the video data that are generated by restoring the previous frame so as to perform the compression process in the current frame. The restoration process includes inverse quantizing the output of the quantizer 140 through the inverse quantizer 160, and performing inverse DCT on the same through the inverse DCT unit 170.

The inter predictor 180 performs an inter prediction process for each macroblock by using the restored previous frame, and performs a corresponding motion estimation process. Also, the inter predictor 180 determines the optimized inter mode having the minimum rate-distortion cost through the inter prediction process, and determines the corresponding minimum rate-distortion cost.

The intra predictor 190 performs a prediction process for each search mode to select the intra mode having the minimum rate-distortion cost from among the search modes. The video encoder selects the mode having the lesser rate-distortion cost as a prediction mode for the corresponding frame from among the inter mode and the intra mode having the selected minimum rate-distortion cost through the inter predictor 180 and the intra predictor 190. When the prediction mode for the corresponding macroblock is finally determined, the residual image/mode information and motion vector following the corresponding prediction mode are generated into a compression stream through the above-described process for the intra frame.

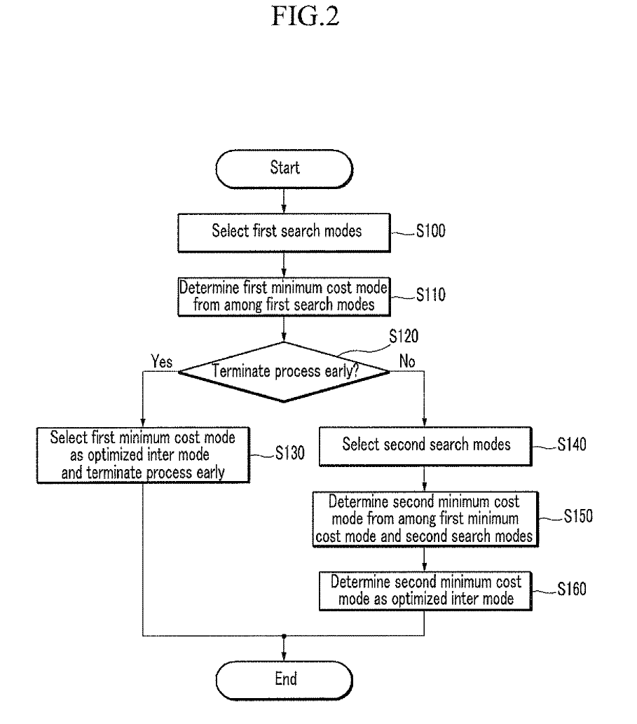

FIG. 2 is a flowchart for a video encoder according to an exemplary embodiment of the present invention to determine an inter mode.

On receiving the video data corresponding to the inter frame, the inter predictor 180 performs an inter prediction process for each macroblock by using the data that are divided by macroblocks by the block unit divider 100.

Referring to FIG. 2, on receiving a current macroblock, the inter predictor 180 selects initial candidate modes by using the temporal similarity with the previous frame (S100). That is, the inter predictor 180 selects the first search modes by using the optimized inter mode information of the correlation macroblock having the same position as the current macroblock in the previous frame. Here, the previous frame represents the frame that is input to the video encoder and is then encoded before the current frame in which the current macroblock is positioned.

The inter predictor 180 performs an inter prediction process on the selected first search modes, and determines the mode having the minimum rate-distortion cost (referred to as a first minimum cost mode hereinafter) from among the first search mode (S110).

The inter predictor 180 performs an inter prediction process on the search mode and determines whether to terminate the inter mode determination process early. In order to achieve this, the inter predictor 180 compares the rate-distortion costs of the correlation macroblock and the current macroblock. That is, the inter predictor 180 terminates the inter mode determination process early when the rate-distortion cost of the current macroblock is less than the rate-distortion cost of the correlation macroblock. Here, the rate-distortion cost of the correlation macroblock represents the rate-distortion cost corresponding to the optimized inter mode of the correlation macroblock, and the rate-distortion cost of the current macroblock represents the rate-distortion cost corresponding to the first minimum cost mode of the current macroblock. Since the rate-distortion cost of the correlation macroblock is calculated from the encoding process of the previous frame, the inter predictor 180 does not perform an additional computation process for calculating the rate-distortion cost of the correlation macroblock.

When the early termination is determined, the inter predictor 180 selects the first minimum cost mode as the optimized inter mode of the current macroblock, and terminates the inter mode determination process early (S143). When the early termination condition is not satisfied, the inter predictor 180 selects second search modes for performing a subsequent inter prediction process (S140).

When the second search modes are determined, the inter predictor 180 additionally performs an inter prediction process on the corresponding search modes, and determines the second minimum cost mode having the minimum rate-distortion cost from among the first minimum cost mode and the second search modes (S150).

The inter predictor 180 finally determines the second minimum cost mode as the optimized inter mode of the current macroblock and terminates the inter prediction process (S160).

The rate-distortion cost of the optimized inter mode determined as described above is compared again with the rate-distortion cost of the intra mode determined through intra prediction, and is then used to determine the prediction mode of the current macroblock.

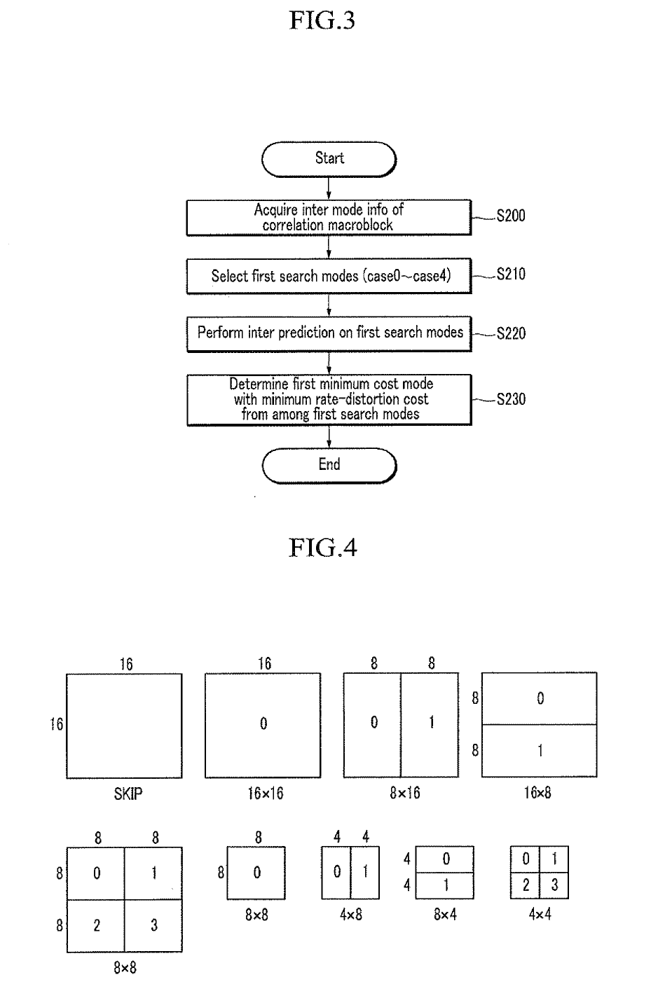

A method for selecting the initial search mode in S100 will now be described with reference to FIG. 3 to FIG. 6.

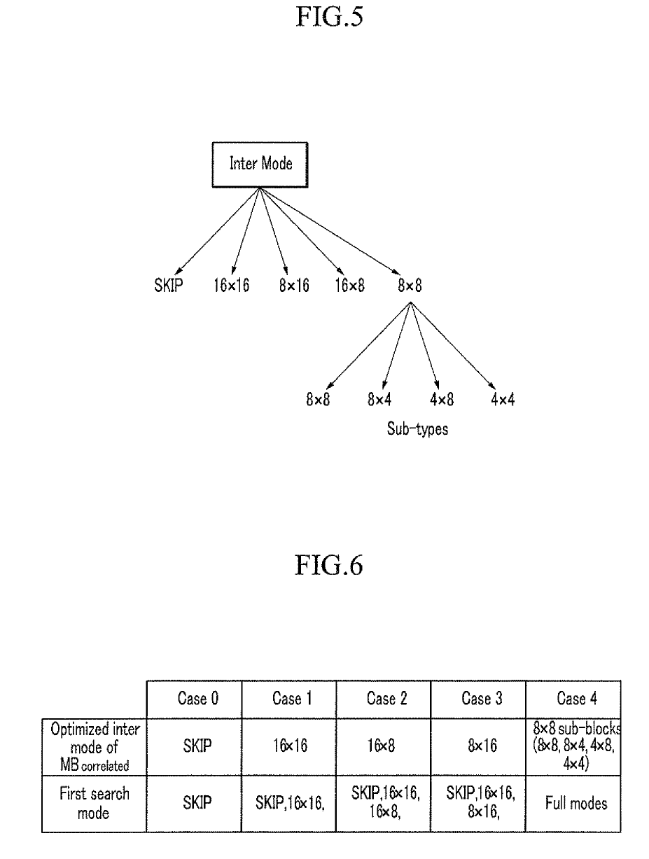

FIG. 3 is a flowchart for a video encoder according to an exemplary embodiment of the present invention to select a first search mode, FIG. 4 shows search modes according to an exemplary embodiment of the present invention, and FIG. 5 is a tree-type search mode according to an exemplary embodiment of the present invention. FIG. 6 show first search modes according to an exemplary embodiment of the present invention.

Referring to FIG. 3, the inter predictor 180 acquires optimized inter mode information of the correlation macroblock so as to select the first search modes (S200). There is no need to additionally generate the optimized inter mode information for each macroblock of the previous frame since the optimized inter mode information is generated during the encoding process of the previous frame.

The inter predictor 180 determines the first search modes for performing the inter prediction process based on the optimized inter mode information of the correlation macroblock (S210). The determination of the first search modes as described above is based on the temporal similarity between continuous frames according to the characteristic of video, and the correlation between the inter modes becomes very great in the case of the macroblock in which movement between continuous frames is rare.

As shown in FIG. 4, the candidate modes required for inter prediction in the H.264/AVC method are classified as SKIP, 16×16, 16×8, 8×16, 8×8, 4×8, 8×4, and 4×4. That is, one of 16×16, 16×8, 8×16, and 8×8 is selected according to the block size used for motion estimation, and in the case of 8×8, one of 8×8, 4×8, 8×4, and 4×4 is selected as a sub-block mode for each 8×8 block depending on the size of dividing one 8×8 block into smaller ones. Also, the SKIP mode does not perform the motion estimation process, which is shown as a tree in FIG. 5.

The inter predictor 180 performs an inter prediction process on the modes that are selected as search modes from among the above-noted 8 inter modes, compares the rate-distortion costs that are generated for the respective search modes, and finally selects the inter mode having the minimum rate-distortion cost as the inter mode of the current macroblock.

Referring to FIG. 6, the first search mode is selected to include the mode that has a block size that is greater than the optimized inter mode of the correlation macroblock, and the SKIP mode. For example, when the optimized inter mode of the correlation macroblock is the 16×16 mode (Case 1), the first search mode becomes the SKIP mode and the 16×16 mode. The optimized inter mode information in the previous frame has a great correlation with the macroblock at the same position in the current frame. Therefore, determination of the first search mode according to the optimized inter mode of the correlation macroblock allows efficient selection of the first search mode without additional calculation. Regarding Case 4 shown in FIG. 6, when the inter mode of the correlation macroblock is 8×8 (8×8 sub-block modes: 8×8, 8×4, 4×8, and 4×4), the inter prediction process is performed on all types of search modes, that is, the full modes.

Referring to FIG. 3 again, when the first search modes are determined, the inter predictor 180 performs an inter prediction process for each first search mode (S220), and calculates the corresponding rate-distortion cost for each first search mode. Also, the inter predictor 180 selects the search mode having the minimum rate-distortion cost as a first minimum cost mode from among the first search modes (S230).

In general, the video encoder selects the optimal compression condition by using the rate-distortion optimization in the prediction process. Equation 1 expresses the method for calculating the rate-distortion cost (J_{R-D}), and the rate-distortion costs of the first search modes can found in the inter prediction process as follows.

J_{R-D}=SAD_{Mode}+λ·{R(Header)+R(Residual)} [Equation 1]

Here, J_{R-D} is a cost function for the rate-distortion cost, SAD_{Mode} is the sum of errors in the given prediction mode, that is, the corresponding search mode, λ is the Lagrangian coefficient, R(x) is the amount of bits for coding the variable x, Header is header information of the current macroblock, and Residual is residual data of the current macroblock when the inter prediction process is performed with the given prediction mode.

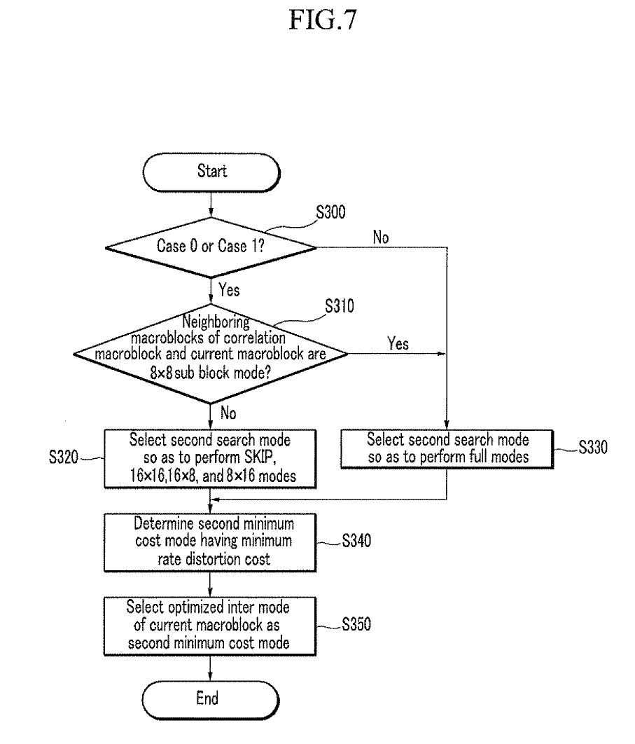

The method for selecting the first search mode and then selecting the second minimum cost mode of S140 and S150 in FIG. 2 will now be described in detail with reference to FIG. 7 to FIG. 9.

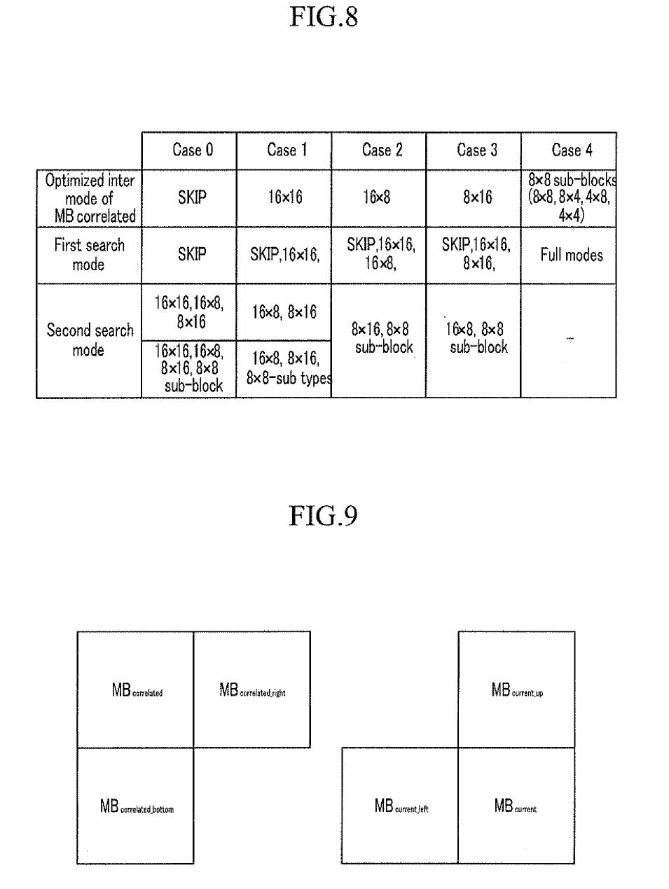

FIG. 7 shows a flowchart for a video encoder according to an exemplary embodiment of the present invention to determine an inter mode according to selection of a second search mode, FIG. 8 shows an example of selecting a second search mode according to an exemplary embodiment of the present invention, and FIG. 9 shows neighboring macroblocks used for determining a second search mode according to an exemplary embodiment of the present invention.

Referring to FIG. 7, when the early termination condition is not satisfied, the inter predictor 180 selects the second search modes so as to additionally perform the inter prediction process. The inter predictor 180 selects the second search mode according to the optimized inter mode of the correlation macroblock in a like manner of the above-described first search mode selection method. When the inter mode corresponding to the correlation macroblock is one of 16×8, 8×16, and 8×8 sub-block modes (i.e., Case 2, Case 3, or Case 4 in FIG. 6), the inter predictor 180 selects the second search mode so as to perform the inter prediction process on the full modes (S330). For example, as shown in FIG. 8, the inter predictor 180 performs the inter prediction process by adding the 16×8 mode and the 8×8 sub-block mode as the second search mode since it has selected the SKIP, 16×16, and 8×16 modes as the first search mode in the case of Case 3.

Further, when the optimized inter mode of the correlation macroblock is the SKIP mode (Case 0) or the 16×16 (Case 1) mode (S300), the inter predictor 180 determines whether to select the second search mode and thereby perform the prediction process on the SKIP, 16×16, 16×8, and 8×16 modes according to a predetermined condition, or to select the second search mode and thereby perform the prediction process on the full modes SKIP, 16×16, 16×8, 8×16, and 8×8 sub-block modes (8×8, 8×4, 4×8, and 4×4) (S310).

As shown in FIG. 9, the inter predictor 180 uses neighboring macroblocks (MB_{correlated}_{_{—}}_{right}, MB_{correlated}_{_{—}}_{bottom}) of the correlation macroblock and neighboring macroblocks (MB_{current}_{_{—}}ᵤₚ, MB_{current}_{_{—}}_{left}) of the current macroblock so as to determine the second search mode for Case 0 and Case 1. That is, when the optimized inter mode of the neighboring macroblocks of the correlation macroblock and the current macroblock is one of the 8×8 sub-block modes, the inter predictor 180 determines the second search mode so as to perform a prediction process on the full modes (S330). In another case, the inter predictor 180 determines the second search mode so as to perform a prediction process on the SKIP, 16×16, 16×8, and 8×16 modes (S320).

The optimized inter modes of the bottom macroblock (MB_{correlated}_{_{—}}_{bottom}) and the right macroblock (MB_{correlated}_{_{—}}_{right}) from among the neighboring macroblocks of the correlation macroblock have been used so as to determine the second search mode in the exemplary embodiment of the present invention, and it is also allowable to use the optimized inter mode of at least one of neighboring macroblock from among the top macroblock (MB_{correlated}_{_{—}}ᵤₚ), bottom macroblock (MB_{correlated}_{_{—}}_{bottom}), left macroblock (MB_{correlated}_{_{—}}_{left}), and right macroblock (MB_{correlated}_{_{—}}_{right}) of the correlation macroblock (MB_{correlated}).

As described, the method for using the optimized inter mode of the neighboring macroblocks (MB_{correlated}_{_{—}}_{right}, MB_{correlated}_{_{—}}_{bottom}, MB_{correlated}_{_{—}}ᵤₚ, MB_{correlated}_{_{—}}_{left}, MB_{current}_{_{—}}ᵤₚ, and MB_{current}_{_{—}}_{left}) of the correlation macroblock and the current macroblock for the second search mode so as to determine the second search mode can be performed without any additional process since the neighboring macroblocks are encoded before the current macroblock (MB_{current}) and the optimized inter modes thereof are determined.

When the inter mode of the correlation macroblock (MB_{correlated}) is one of the 8×8 sub-block modes, the first minimum cost mode is selected as the optimized inter mode of the current macroblock without additionally selecting a second search mode since the first search mode already includes the full modes. The 8×8 sub-block mode includes 8×8, 8×4, 4×8, and 4×4 modes, and represents the optimized inter mode that is selected for each 8×8 block when the current macroblock is divided into 8×8 blocks and the optimized inter mode for each 8×8 block is selected.

Referring to FIG. 7, when the second search modes are selected as described above in S320 and S330, the inter predictor 180 performs an inter prediction process on the second search modes. The inter predictor 180 determines the second minimum cost mode having the minimum rate-distortion cost from among the search modes (the first and the second search mode) that has performed the prediction process on the current macroblock (S340), and selects the second minimum cost mode as the optimized inter mode of the current macroblock (S350).

The above-described method for determining the optimized inter mode of the macroblock by performing the inter prediction process on a plurality of search modes that are selected according to a predetermined condition reduces complexity, compared to the conventional method for determining the mode having the minimum rate-distortion cost as the optimized inter mode by performing a prediction process on the full modes. In addition, the method is applicable to the real-time image processing system by reducing complexity and thereby increasing efficiency of the encoding system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for determining an inter mode in a method for a video encoder to select an inter mode of a current macroblock to be encoded in a current frame, the method comprising:
selecting a first minimum cost mode according to an inter mode of a correlation macroblock having the same position as the current macroblock in a previous frame; and
determining an inter mode of the current macroblock based on a rate-distortion cost of the first minimum cost mode and a rate-distortion cost of the correlation macroblock.

2. The method of claim 1, wherein
the determining the inter mode includes:
determining whether to select a second minimum cost mode other than the first minimum cost mode based on the rate-distortion cost of the first minimum cost mode and the rate-distortion cost of the correlation macroblock; and
determining the first minimum cost mode as the inter mode when not selecting the second minimum cost mode, and determining the second minimum cost mode as the inter mode when selecting the second minimum cost mode.

3. The method of claim 2, wherein:
the selecting the first minimum cost mode includes
selecting at least one first search mode according to the inter mode of the correlation macroblock, and
selecting the first minimum cost mode from among the at least one first search mode; and
the determining the inter mode of the current macroblock further includes
selecting at least one second search mode according to the inter mode of the correlation macroblock, and
selecting the second minimum cost mode from among the first minimum cost mode and the at least one second search mode.

4. The method of claim 3, wherein
the selecting at least one first search mode includes
selecting the inter mode that is equal to or greater than the inter mode of the correlation macroblock and the SKIP mode as the at least one first search mode.

5. The method of claim 3, wherein
the selecting at least one second search mode includes
determining the at least one second search mode so that the at least one first search mode and the at least one second search mode may include the full inter modes or a partial inter mode according to the inter mode of the correlation macroblock, and
the full inter modes include a first mode having a sub-block mode and a second mode having a sub-block mode, and the partial inter mode is the first mode.

6. The method of claim 5, wherein
the determining at least one second search mode includes:
determining whether the inter mode of at least one neighboring macroblock of the correlation macroblock and the inter mode of at least one neighboring macroblock of the current macroblock are respectively one of the second modes; and
determining the at least one second search mode so that the at least one first search mode and the at least one second search mode may include the full modes when the inter mode of at least one neighboring macroblock of the correlation macroblock and the inter mode of at least one neighboring macroblock of the current macroblock are the second modes.

7. The method of claim 6, wherein
the at least one neighboring macroblock of the correlation macroblock includes a bottom macroblock of the correlation macroblock and a right macroblock of the correlation macroblock, and the at least one neighboring macroblock of the current macroblock includes a top macroblock of the current macroblock and a left macroblock of the current macroblock.

8. The method of claim 6, wherein
determining the at least one second search mode so that the at least one first search mode and the at least one second search mode may include the partial inter mode when at least one of the inter mode of at least one neighboring macroblock of the correlation macroblock and the inter mode of at least one neighboring macroblock of the current macroblock is not the second mode.

9. The method of claim 5, wherein
the inter mode of the correlation macroblock corresponds to one of the SKIP mode and the mode having the greatest size.

10. The method of claim 5, wherein
the selecting at least one second search mode includes
determining the at least one second search mode so that the at least one first search mode and the at least one second search mode may include the full inter modes when the inter mode of the correlation macroblock does not have the SKIP mode and the mode having the greatest size.

11. The method of claim 5, wherein
the first mode includes the SKIP, 16×16, 16×8, and 8×16 modes, and the second mode includes an 8×8 sub-block mode.

12. The method of claim 3, wherein
the first minimum cost mode has the minimum rate-distortion cost from among the at least one first search mode, and
the second minimum cost mode has the minimum rate-distortion cost from among the first minimum cost mode and the at least one second search mode.

13. A recording medium for recording a program for executing a method disclosed by claim 1

14. A method for determining an inter mode in a method for a video encoder to select an inter mode of a current macroblock to be encoded in a current frame, the method comprising:
selecting at least one first search mode according to an inter mode of a correlation macroblock having the same position as the current macroblock in a previous frame;
selecting the minimum cost mode from among the at least one first search mode;
determining whether to terminate an inter mode determination process early based on a rate-distortion cost of the minimum cost mode and a rate-distortion cost of the correlation macroblock; and
determining the inter mode according to the determination result, and
the determining the inter mode includes
determining the minimum cost mode as the inter mode when terminating the inter mode determination process, and selecting at least one second search mode and selecting the inter mode from among the minimum cost mode and the at least one second search mode when not terminating the inter mode determination process.

15. The method of claim 14, wherein
the selecting the inter mode includes
selecting the at least one second search mode so that the at least one first search mode and the at least one second search mode may include the full inter modes when the inter mode of the correlation macroblock corresponds to a block size that is less than 16×16.

16. The method of claim 15, wherein
the selecting the inter mode includes:
determining whether an inter mode of at least one neighboring macroblock of the correlation macroblock and an inter mode of at least one neighboring macroblock of the current macroblock are respectively one of the 8×8 sub-block mode when an inter mode of the correlation macroblock is one of the SKIP mode and the 16×16 mode; and
selecting the at least one second search mode so that the at least one first search mode and the at least one second search mode may include the full modes when the inter mode of at least one neighboring macroblock of the correlation macroblock and the inter mode of at least one neighboring macroblock of the current macroblock are respectively one of the 8×8 sub-block mode.

17. The method of claim 16, wherein
the selecting the inter mode further includes
selecting the at least one second search mode so that the at least one first search mode and the at least one second search mode may include the SKIP, 16×16, 16×8, and 8×16 modes when at least one of the inter mode of at least one neighboring macroblock of the correlation macroblock and the inter mode of at least one neighboring macroblock of the current macroblock are not the 8×8 sub-block mode.
